(19) United States
(12) Patent Application Publication
(10) Pub. No.: US 2007/0022403 A1
(43) Pub. Date: Jan. 25, 2007

(54) Software system development apparatus

(75) Inventors: Wayne D. Brandt, Morton, IL (US); Vernon R. Smith, Peoria, IL (US); Walt E. Earleson, Morton, IL (US); Michael E. Roth, Edwards, IL (US); Dale B. Herget, Mapleton, IL (US); Steven C. Bray, Dunlap, IL (US); Wayne J. Wulfert, East Peoria, IL (US); Jeffrey S. Morris, Bartonville, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/185,709

(22) Filed: Jul. 21, 2005

(51) Int. Cl. G06F 9/44

(52) U.S. Cl. 717/100

(57) ABSTRACT

A software system development apparatus is provided. The software system development apparatus may include a processor and a computer-readable medium operatively coupled to the processor. The apparatus may also include a system design tool program stored on the computer-readable medium that, when executed by the processor, is operable to generate a real-time embedded control software system by selecting from a collection of reusable software components stored in a catalog. The system design tool may also be configured to establish compatibility information about the compatibility of the software system with other real-time embedded control system components and package the compatibility information together with the software system onto a computer-readable medium as an installation package.

### TECHNICAL FIELD

The present disclosure is directed to a software system development apparatus and, more particularly, to a software system development apparatus configured to develop and package real-time embedded control software systems together with compatibility information.

### BACKGROUND

Many devices include real-time embedded control systems. Real-time embedded control systems may be associated with work machines, such as construction equipment, which may include electrical components that are communicably coupled to each other through one or more communication conduits. Examples of such electrical components may include electronic control units (ECUs), network managers, control panels, etc.

A software system can be designed using a computer-generated design environment. A design environment may include a system design tool. A system design tool may include a software program that allows a designer to design a system using a function-based approach. In addition, a system design tool may include a database, often referred to as a “catalog,” identifying software components that are available to the design tool for building the software system. Each identified software component may be operable to perform a particular function and may be designed for use in conjunction with a particular piece of electronic hardware.

A system design tool may present a graphic user interface (GUI) to the designer. Through the GUI, the design tool may accept input, which may indicate one or more functions or sub-functions that the system would have to perform in order to perform the overall function of the system. The GUI may also accept input indicating the interaction between the sub-functions. For example, the design tool may be used to select, from the catalog, software components that perform the desired sub-functions. The design tool may also be used to conceptually build the software system by facilitating assembly of the identified software components according to the desired interaction of the sub-functions.

Historically, the way in which newly-developed real-time embedded control software systems have been installed has been a manual process, completed by a technician. The technician may have been provided with a printed copy of compatibility information (sometimes referred to as a “bill of materials”) and/or installation instructions (sometimes referred to as a “service information”), which may be based on the compatibility information. The compatibility information may indicate which real-time embedded control systems and system components are compatible with the newly developed software system.

For example, the technician would often be provided with a list of systems and components compatible with the newly developed software system. The technician would be required to somehow determine which systems and components were already installed on a particular machine, then determine from the installation information what steps need to be performed in order to install the newly-developed software system.

This process can be cumbersome, time consuming, and unreliable. Not only does the technician need to refer to three different sets of information, but such information must be located and available in the first place. If updates are to be performed on a particular machine on which new software systems have already been installed after initial manufacturing of the machine, then the technician would need accurately kept records of what new software systems were installed or at least an up-to-date inventory of systems and components in place on the machine. Maintaining and locating such records can be even more of a problem when the machine is serviced and/or owned by more than one entity.

Systems have been developed that include a bill of materials along with a computer file. For example, U.S. Pat. No. 4,862,376, issued on Aug. 29, 1989 to Hogan et al. (“the '376 patent”), discloses a system configured to build a CAD/CAM file based on input from a part designer, wherein the system establishes a bill of materials, which includes a listing of each part the designer designs for a given system. For example, if a designer were designing parts for a lawnmower, as each part was designed it would be added to a bill of materials.

While the system of the '376 patent may package a bill of materials with a computer file, the system of the '376 patent is not configured to package a bill of materials for real-time embedded control software systems. Further, the “bill of materials” discussed in the '376 patent does not appear to include compatibility information about the parts listed in the bill of materials.

The disclosed software system development apparatus is directed toward overcoming one or more of the shortcomings set forth above.

### SUMMARY OF THE INVENTION

In one aspect, the present disclosure is directed to a software system development apparatus. The software system development apparatus may include a processor and a computer-readable medium operatively coupled to the processor. The apparatus may also include a system design tool program stored on the computer-readable medium that, when executed by the processor, is operable to generate a real-time embedded control software system by selecting from a collection of reusable software components stored in a catalog. The system design tool may also be configured to establish compatibility information about the compatibility of the software system with other real-time embedded control system components and package the compatibility information together with the software system onto a computer-readable medium as an installation package.

In another aspect, the present disclosure is directed to a method of developing a software system. The method may include generating a real-time embedded control software system by selecting from a collection of reusable software components. The method may also include establishing compatibility information about the compatibility of the software system with other real-time embedded control system components and packaging the compatibility information together with the software system onto a computer-readable medium as an installation package.

### BRIEF DESCRIPTION OF THE DRAWINGS

FIG. 1 is a schematic of a software system development apparatus interfaced with a maintenance module according to an exemplary disclosed embodiment.

### DETAILED DESCRIPTION

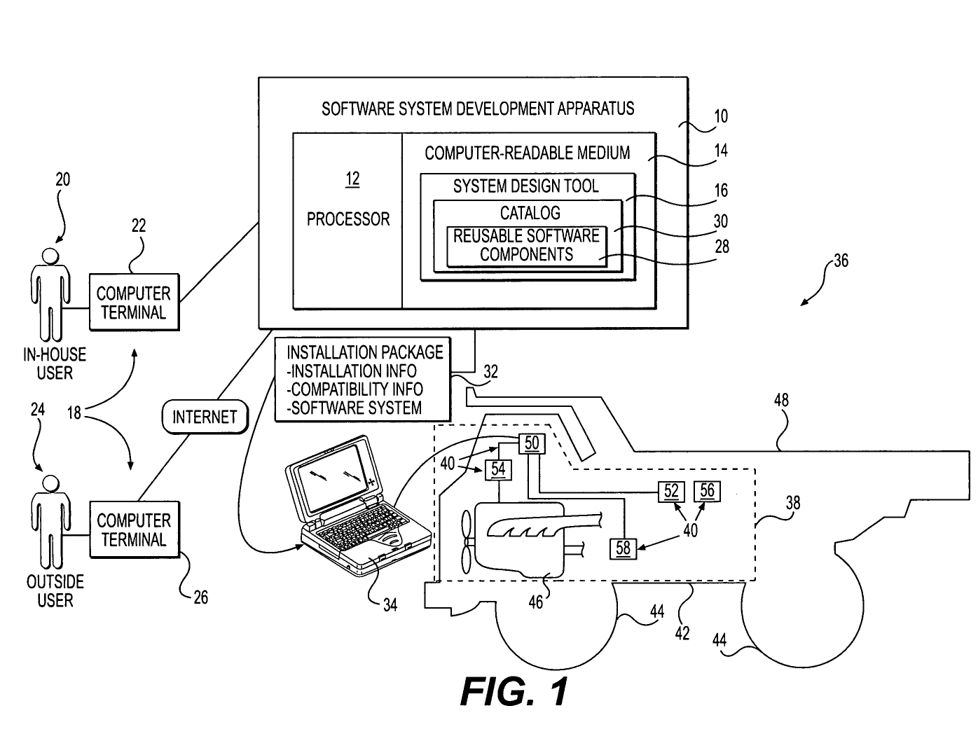

FIG. 1 illustrates a software system development apparatus 10, which may include a processor 12, and a computer-readable medium 14 operatively coupled to processor 12. A program, such as a system design tool 16, may be stored on computer-readable medium 14.

Computer-readable medium 14 may include any hardware configured to store computer-readable software, such as any appropriate type of mass storage provided to store any type of information needed for software system development apparatus 10 to function. For example, computer-readable medium 14 may include one or more hard disk devices, optical disk devices, or other storage devices to provide storage space.

System design tool 16 may be operable to generate real-time embedded control software systems for real-time embedded control systems. For purposes of this disclosure, the term “embedded control system” shall be defined as an electronic system wherein an electronic controller controls one or more electronic components. An example of “real-time” embedded control may include controlling a hardware and/or software system in a manner that allows the controlled system to perform substantially in accordance with its intended design specification.

One example of a real-time embedded control system may include an anti-lock braking system (ABS) for a vehicle. In an anti-lock braking system, a controller may transmit control signals to electronically operated valves in the braking system to regulate the pressure in the brake system. This pressure may be regulated to modulate wheel deceleration, which may be monitored by wheel speed sensors. In the context of ABS, the transmission of control signals occurs fast enough to cause pressure in the braking system to drop before the wheel stops turning. Some anti-lock braking systems can open and close the valves 15 times per second or more. In order to effect such rapid actuation of the valves, the control signals must be transmitted even more quickly.

The speed of delivery of commands and/or generation of outputs may be dependent on several factors including, for example, the operating speed of the system being controlled. For example, an engine control module (ECM) may deliver commands and monitor engine operating parameters at a relatively faster rate (e.g., on the order of milliseconds) as operating parameters of an engine must be controlled fast enough to keep up with an engine operating at several hundred to several thousand RPM. Conversely, a simple data collection system, such as a dump cycle counter, may operate in real-time, but at slightly slower rates of data transmission (e.g., up to 1 second).

As illustrated in FIG. 1, software system development apparatus 10 may interface with computer terminals 18 operable by users accessing a system design tool 16 in various ways. FIG. 1 shows an in-house user 20 accessing system design tool 16 from within a host organization of system design tool 16. For example, in-house user 20 may include a user accessing system design tool 16 from an in-house computer terminal 22. In-house user 20 may be integrated with a local network of a company that hosts system design tool 16 for use by its employees, maintains system design tool 16, and/or serves as administrator of system design tool 16.

FIG. 1 also shows an outside user 24 (i.e., not in-house) accessing system design tool 16 from an outside computer terminal 26. For example, outside user 24 may include a customer (e.g., a designer who uses system design tool 16 and/or software components stored therein) or outside vendor (e.g., an entity from whom the host organization may obtain software components and/or other information) accessing system design tool 16 via the internet, as shown in FIG. 1, or via any other kind of communications data link or portal.

System design tool 16 may be operable to generate (e.g., when executed by processor 12 in response to user input) real-time embedded control software systems by selecting from a collection of reusable software components 28 stored and described in a catalog 30. System design tool 16 may be operable to generate a real-time embedded control software system by selecting multiple components from a collection of reusable software components stored in a catalog and assemble the components together.

Reusable software components 28 may be stored and described in catalog 30 in accordance with the Reusable Asset Specification (RAS) developed under the guidance of The Object Management Group (OMG), a computer industry standards organization. RAS defines a standard way to package reusable software. A reusable software asset may be any cohesive collection of artifacts that solve a specific problem or set of problems in software development. A reusable software asset (e.g., software component) is created with the intent of reuse. A reusable software asset is distinguished from other artifacts or collections of artifacts used in software development by its packaging. A reusable software asset's packaging may be the set of files that implement the solution and a structured set of information that defines and describes the reusable software asset as a whole.

System design tool 16 may also be configured to establish compatibility information (e.g., a “bill of materials”) about the compatibility of the software system with other real-time embedded control system components. System design tool 16 may be further configured to package the compatibility information together with the software system onto a computer-readable medium as an installation package 32. In addition, system design tool 16 may be operable to package installation information (e.g., service information) as part of installation package 32.

System design tool 16 may also be operable to transmit installation package 32 to a destination outside software system development apparatus 10. For example, system design tool 16 may be configured to transmit installation package 32 to a maintenance module 34 configured to update real-time embedded control software systems associated with a work machine 36.

Maintenance module 34 may be configured to interface with a real-time embedded control system 38. Maintenance module 34 may include a service tool configured to transfer data to and/or receive data from electrical components 40 of real-time embedded control system 38. For example, maintenance module 34 may include any type of device for transferring data, such as, a laptop computer, a PDA, or other specialized equipment configured to interface with one or more of electrical components 40. Maintenance module 34 may be configured to update software of real-time embedded control system 38 by, for example, “flashing” or “flash reprogramming” one or more memories associated with electrical components 40. Installation of new or update software on real-time embedded control system 38 may be facilitated by the compatibility information and/or installation information packaged with the new software. The installation may be completed with various levels of automation. That is, once initiated by a technician, the installation process may be completed automatically in some embodiments. In other embodiments, certain portions of the installation process may be automated due to the inclusion of various compatibility information and/or installation information.

Work machine 36 may include a frame 42, one or more traction devices 44, a power source 46, and a real-time embedded control system 38, including one or more electrical components 40. Although work machine 36 is shown as a truck, work machine 36 could be any type of machine having a real-time embedded control system. Accordingly, traction devices 44 may be any type of traction devices, such as, for example, wheels, as shown in FIG. 1, tracks, belts, or any combinations thereof.

Power source 46 may be any type of power source. For example, power source 46 may include an electric motor, fuel cell, engine, or any other type of power source. Power source 46 may include any type of engine, including gasoline engines, diesel engines, natural gas engines, or any other type of engine. One or more operating parameters of power source 46 may be controllable with real-time embedded control system 38.

Work machine 36 may also include a work tool 48. Such a work tool may include any type of device controllable by real-time embedded control system 38 to perform a function. As shown in FIG. 1, work tool 48 includes a dump body of a hauling vehicle. However, work tool 48 could include any device configured to perform any function of which work machine 36 is capable. For example, work tool 48 could include any type of work implement, such as buckets (e.g., excavator shovels, loader buckets, etc.), blades (e.g., dozer blades, motor grader blades, etc.), grapples, jackhammers, or any other actuatable device.

Real-time embedded control system 38 may be any electronic system configured to control one or more functions of work machine 36. Work machine 36 may be configured to monitor output, directly or indirectly, of components performing these functions. Real-time embedded control system 38 may be configured to control these functions based on the output monitored by work machine 36. Real-time embedded control system 38 may be configured to communicate between electrical components 40 within a local network, wherein one or more of electrical components 40 may be associated with a node of the local network. Electrical components 40 may include, for example, one or more processors, such as an electronic control unit (ECU) 50, an ECU 52, and/or an engine control module (ECM) 54. Electrical components 40, particularly ECU 50, ECU 52, and/or ECM 54, may include memory. Exemplary types of memory may include EPROM or EEPROM, such as flash memory, or any other kind of memory.

ECM 54 may be configured to control one or more operating parameters of power source 46. For example, ECM 54 may be configured to control electronic fuel injectors, electronic throttle controls, etc. ECM 54 may be configured to control these and/or other parameters based on data collected by ECM 54, such as emissions measurements, oxygen content in the exhaust, and closed loop feedback, such as fuel injector operation, air intake, and throttle position.

Electrical components 40 may also include one or more output devices controllable by ECUs. For example, ECU 52 may be configured to control operation of other work machine components such as work tool 48. In one embodiment, ECU 52 may be configured to control an output device, such as a solenoid valve 56 operable to control actuation of a hydraulic actuator (not shown) associated with work tool 48. Another example of an output device may include an electronic transmission control 58, which may be controlled by, for example, ECU 50.

An example of a function controlled by real-time embedded control system 38 could include a speed limiting feature. When the dump body (e.g., work tool 48) is in a raised position, ECU 50 may be configured to control gear selection of electronic transmission control 58. Other possibilities for real-time embedded control system 38 may include positioning and/or guidance systems. For example, work machine 36 may be configured to automatically guide itself along a predetermined path of travel based on positioning data determined by, for example, a global positioning system (GPS). In some embodiments, work machine 36 may be configured to control position of work tool 48 (e.g., dozer blades) based on global positioning information, such as GPS data and/or local positioning data, such as from laser-based positioning systems. The disclosed software system development apparatus 10 may facilitate installation of new and/or updated software to one or more of electrical components 40 of real-time embedded control system 38, which may be part of a local network.

### INDUSTRIAL APPLICABILITY

The present disclosure may be applicable to a wide variety of devices. System design tool 16 may be operable to generate real-time embedded control software systems that may be applicable to any kind of work machine. For example, such work machines may include regular household appliances, such as clothes dryers and microwaves, which can have embedded control systems that operate the equipment based on sensor feedback. Clothes dryers may have sensor dry programs which stop the dryer when a moisture sensor detects that the clothes are dry. Microwaves can have programs that cook food until a moisture sensor detects that the food is finished cooking.

Real-time embedded control software may also be applicable to more industrial types of equipment, such as HVAC systems (e.g., electronic and, in some cases programmable thermostats) or power generation sets (e.g., gas turbine engines that drive electric generators). Further, real-time embedded control software may be applicable to mobile work machines, such as on-road vehicles, as well as off-road vehicles, including both on-road and off-road construction and/or agricultural equipment. Such mobile work machines may include passenger cars, on and off-road hauling vehicles (e.g., dump trucks), earth moving equipment (e.g., track-type tractors (a.k.a. bulldozers), loaders, excavators, etc).

Such real-time embedded control software systems may be operable to control real-time embedded control systems, which may include any electronic system configured to control one or more functions of a work machine with which the embedded control system is associated. For example, an embedded control system of a work machine may be configured to monitor output, directly or indirectly, of components performing functions of the work machine. The embedded control system may be configured to control these functions based on the output monitored by the work machine. An embedded control system may be configured to communicate between electrical components within a local network, wherein the electrical components may be associated with a node of the local network. Embedded control system components may include, for example, one or more processors, such as electronic control units (ECUs) and/or an engine control module (ECM). Embedded control system components, particularly ECUs and/or ECMs, may include memory, such as EPROM or EEPROM, such as flash memory, or any other kind of memory.

An ECM may be configured to control one or more operating parameters of a power source (e.g., an engine). For example, an ECM may be configured to control electronic fuel injectors, electronic throttle controls, etc. An ECM may be configured to control these and/or other parameters based on data collected by the ECM, such as emissions measurements, oxygen content in the exhaust, and closed loop feedback, such as fuel injector operation, air intake, and throttle position.

Embedded control system components may also include one or more output devices controllable by an ECU. The ECU may be configured to control operation of other work machine components, such as work tools. For example, a controllable output device may include an electronic transmission control.

Exemplary methods of using the disclosed software system development apparatus 10 may include generating a real-time embedded control software system by selecting from a collection of reusable software components 28. In some embodiments, the method may include assembling more than one of the components together. In addition, such methods may include establishing compatibility information about the compatibility of the software system with other real-time embedded control system components. The method may further include packaging the compatibility information and/or installation information together with the software system onto a computer-readable medium as installation package 32. The method may also include transmitting the installation package to a destination outside software system development apparatus 10, such as to maintenance module 34. In addition, the method may include transferring the software system from maintenance module 34 to an electronic control unit (ECU) associated with work machine 36, and installing the software system based on the compatibility information and the installation information. The installation may be accomplished automatically by maintenance module 34, and may include updating software of at least one real-time embedded control system associated with work machine 36.

It will be apparent to those having ordinary skill in the art that various modifications and variations can be made to the disclosed software system development apparatus without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A software system development apparatus, comprising:
a processor;
a computer-readable medium operatively coupled to the processor; and
a system design tool program stored on the computer-readable medium that, when executed by the processor, is operable to:
generate a real-time embedded control software system by selecting from a collection of reusable software components stored in a catalog;
establish compatibility information about the compatibility of the software system with other real-time embedded control system components; and
package the compatibility information together with the software system onto a computer-readable medium as an installation package.

2. The apparatus of claim 1, wherein the system design tool is further operable to package installation information as part of the installation package.

3. The apparatus of claim 1, wherein the system design tool is further operable to transmit the installation package to a destination outside the software system development apparatus.

4. The apparatus of claim 1, wherein the destination includes a maintenance module configured to update real-time embedded control software systems associated with a work machine.

5. The apparatus of claim 1, wherein the system design tool is further operable to generate a real-time embedded control software system by selecting multiple components from a collection of reusable software components stored in a catalog and assembling the components together.

6. A method of developing a software system, comprising:
generating a real-time embedded control software system by selecting from a collection of reusable software components;
establishing compatibility information about the compatibility of the software system with other real-time embedded control system components; and
packaging the compatibility information together with the software system onto a computer-readable medium as an installation package.

7. The method of claim 6, further including packaging installation information as part of the installation package.

8. The method of claim 6, further including transmitting the installation package to a destination outside the software system development apparatus.

9. The method of claim 8, wherein the destination is a maintenance module, and further including transferring the software system from the maintenance module to an electronic control unit (ECU) associated with a work machine, and installing the software system based on the compatibility information and the installation information.

10. The method of claim 9, wherein installing the software system is performed automatically by the maintenance module.

11. The method of claim 9, wherein installing the software system includes updating software of at least one real-time embedded control system associated with the work machine.

12. The method of claim 6, wherein generating the real-time embedded control software system further includes assembling more than one of the components together.

13. A software system development apparatus, comprising:
a processor;
a computer-readable medium operatively coupled to the processor; and
a system design tool program stored on the computer-readable medium that, when executed by the processor, is operable to:
generate a real-time embedded control software system by selecting from a collection of reusable software components stored in a catalog;
establish compatibility information about the compatibility of the software system with other real-time embedded control system components;
package the compatibility information together with the software system onto a computer-readable medium as an installation package;
package installation information as part of the installation package; and
transmit the installation package to a destination outside the software system development apparatus.

14. The apparatus of claim 13, wherein the destination includes a maintenance module configured to update real-time embedded control software systems associated with a work machine.

15. The apparatus of claim 13, wherein the system design tool is further operable to generate a real-time embedded control software system by selecting multiple components from a collection of reusable software components stored in a catalog and assembling the components together.
